(19) United States
(12) Patent Application Publication
(10) Pub. No.: US 2013/0235986 A1
(43) Pub. Date: Sep. 12, 2013

(54) METHOD AND SYSTEM FOR MANAGING CONNECTIONS BETWEEEN TELEPHONE LINE SUBSCRIBERS

(71) Applicant: Hatim Ibrahim, Dubai (AE)

(72) Inventor: Hatim Ibrahim, Dubai (AE)

(73) Assignee: MINATO LIMITED, London (GB)

(21) Appl. No.: 13/426,893

(22) Filed: Mar. 22, 2012

(30) Foreign Application Priority Data
Mar. 6, 2012 (GB) 1203949.1

(51) Int. Cl. H04M 11/00

(52) U.S. Cl. 379/93.01

(57) ABSTRACT

A computer-implemented method of managing telecommunications between telephone line subscribers is provided. The method includes at a first telecommunications operator, receiving from a first telecommunications terminal associated with a first subscriber a connection or message request to connect or send a message to a second subscriber. The connection or message request contains a portable extension number associated with the second subscriber. The method includes resolving the portable extension number to discover information regarding a telephone number and second telecommunications operator used by the second subscriber, routing the connection or message request to the second subscriber via the second telecommunications operator using at least the telephone number, and including an identifier so that the second telecommunications operator knows that the connection or message request originated for a portable extension number.

### CROSS-REFERENCE TO RELATED APPLICATIONS

This application claims priority to GB1203949.1 filed on Mar. 6, 2012, the entire contents of which are incorporated by reference herein.

### FIELD OF THE INVENTION

The invention relates to communication systems and methods that allow telecommunications operators to provide special services for borderless voice, video and messaging connectivity.

### SUMMARY OF THE INVENTION

According to the invention, there is provided a method and systems are set forth in the appended claims. Optional features will be apparent from the description which follows. The invention is a Multi-Level Interconnection Management System (MIMS) and Portable Extension Number (PEN) management system for a global neutral hub which enables telecom operators to offer users a portable extension number, register and make and receive calls and messages with any other operator's users interconnected to a MIMS Hub without bilateral billing or clearance processes.

The MIMS Hub simplifies interconnection and interoperability and eliminates billing between operators.

The MIMS Hub contains a dynamic database for registration management and routing.

Users are able to obtain a PEN and Personal Identification Number (PIN) from any operator connected to the hub, and can port from one operator and telephone number to another operator and telephone number using a simple registration process.

The PEN may consist of 12 digits and the Security PIN code may consist of 4 digits.

The telecom operators allow member subscribers to call any other member subscriber by offering an access code, or special service access short number, for the service, so that a subscriber member may make a call or send a message by dialing the access code followed by the PEN of the other subscriber member.

Advantageously, the invention will enable operators to connect customers, that is, subscriber members, regardless of their location or the particular operators involved.

The MIMS Hub may map, via a database, any telephone number that is assigned to the PEN and forward the call or message to the telephone number.

Each operator will have full access to the database to trace any call or text message, also known as an SMS, to know the destination and origination full details.

As a summary, the MIMS Hub allows operators to offer a special service for specific subscribers and connect them to other same service network subscribers with any other operators around the world, and users will be free to port their service number PEN between operators.

Operators have the option to join and offer any subscriber the ability to get a Portable Extension Number (PEN) and to register and use the services. Operators can determine independently their own billing plan for the subscriber since they have a fixed cost for their connection capacity regardless of where the service will be rerouted and terminated. This is achieved by charging subscriptions to both calling and receiving parties, so that operators can dispense with their usual termination charges.

The advantage of the invention for operators, that they will send the traffic of calls and messages of the special services users without paying other operators for this traffic, their cost will be only for hub interconnection.

Users will be connected with each other regardless the operator they are using, they will be able to port their PEN between operators using a relatively simple process.

Users will have the freedom to get a PEN from any operator that is a member of the MIMS HUB and register, use and port their PEN between the MIMS Hub's operators members.

### BRIEF DESCRIPTION OF THE DRAWINGS

FIG. 1 is a swim lane diagram showing a method of obtaining a new PEN and PIN Code from a system in accordance with the invention.

FIG. 2 is a schematic diagram of a system for implementing the method of obtaining a new PEN and PIN Code shown in FIG. 1.

FIG. 3 is a swim lane diagram showing a method of registering or porting a PEN.

FIG. 4 is a schematic diagram of a system for implementing the method of registering or porting a PEN shown in FIG. 3.

FIG. 5 is a swim lane diagram showing a method of making and receiving calls using a PEN.

FIG. 6 is a schematic diagram showing a system for implementing the method of making and receiving calls using the PEN shown in FIG. 5.

FIG. 7 is a swim lane diagram showing a method of sending and receiving messages using a PEN.

FIG. 8 is a schematic diagram showing a system for implementing the method of sending and receiving messages using the PEN shown in FIG. 7.

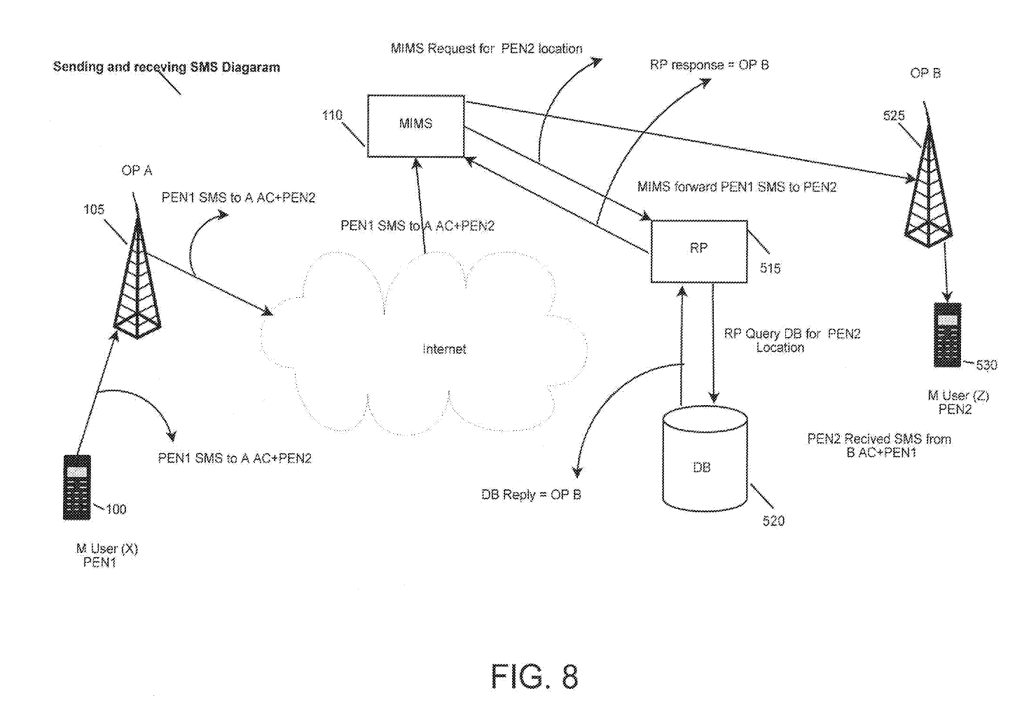

FIG. 9 is a swim lane diagram showing a method of deactivating a PEN.

FIG. 10 is a schematic diagram showing a system for implementing the method of deactivating the PEN shown in FIG. 9.

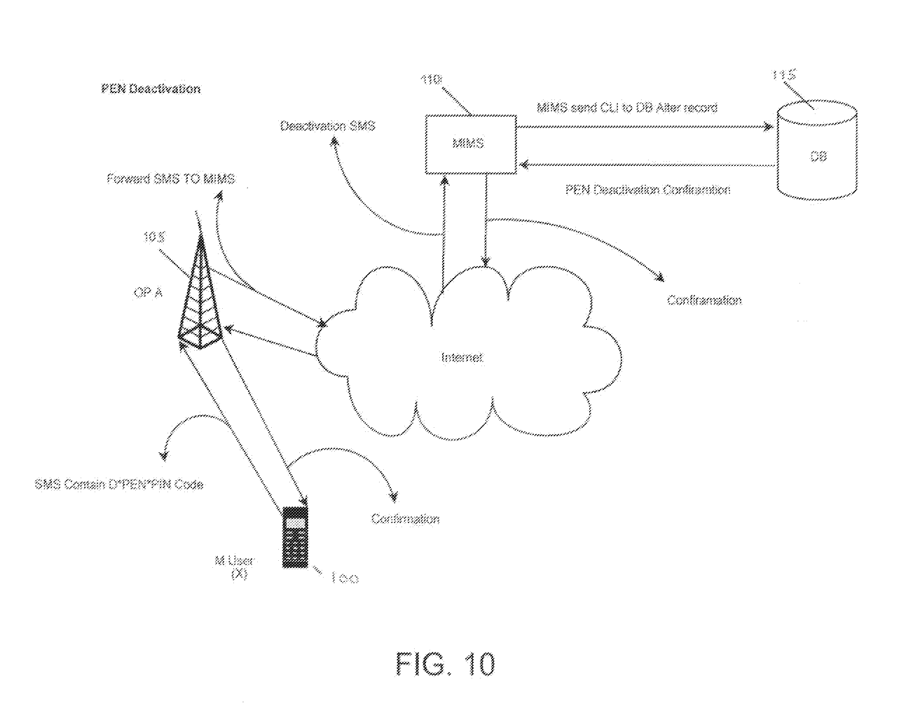

### DETAILED DESCRIPTION OF THE EMBODIMENTS

Exemplary embodiments of the invention are now described with reference to the Figures.

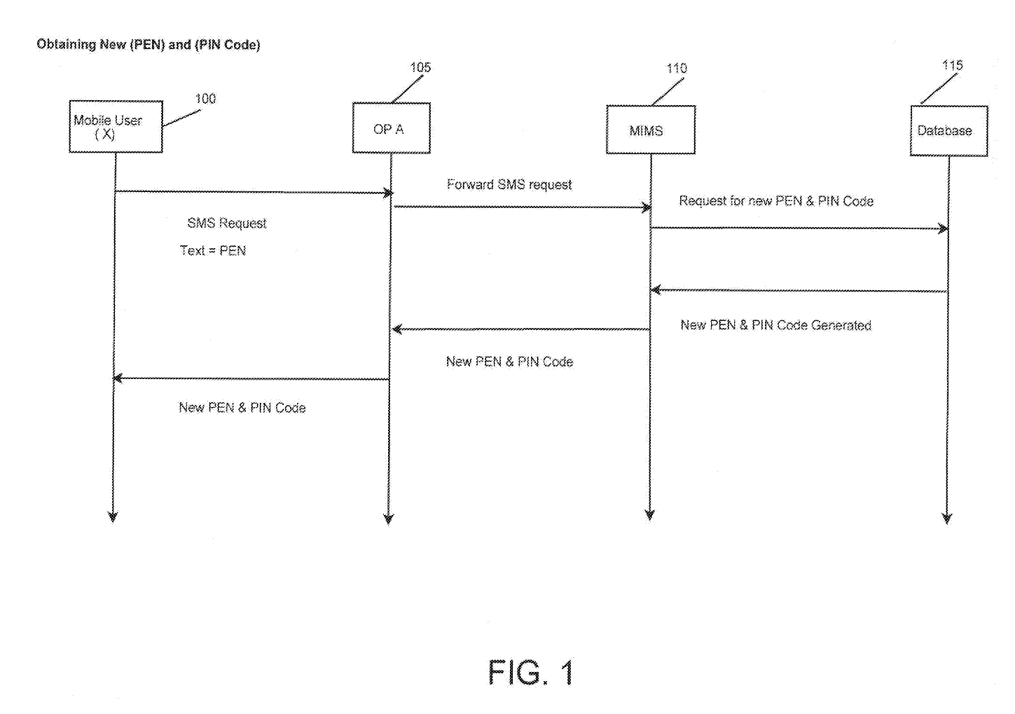

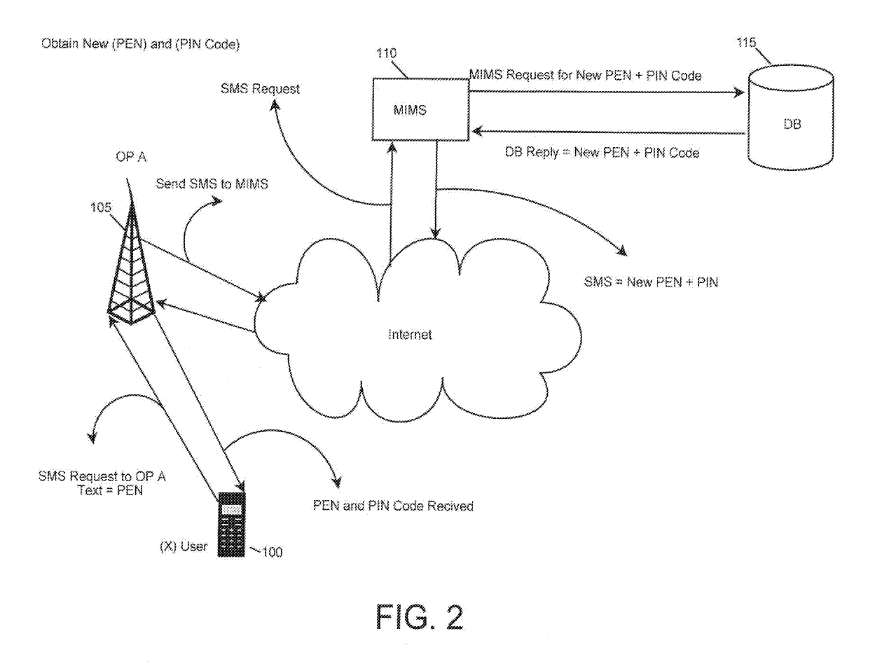

FIGS. 1 and 2 are diagrams showing a method of obtaining a new PEN and PIN Code from a system according to the invention.

Steps to obtain a PEN and PIN Code:
User (X) device 100 sends an SMS to a certain short service access number to be assigned by a mobile or telecommunications operator (A) 105 to which the user's line belongs, e.g. (333), the message may only include the word “PEN”.
The mobile operator 105 receives the request message and forwards it to a Multi-Level Interconnection Management System (MIMS) 110 over IP with caller ID number.
The Multi-Level Interconnection Management System (MIMS) 110 forwards the information to a database 115.
The database 115 generates a new PEN and PIN Code and sends them to the operator 105 to deliver them to the user (X) device 100 which sent the request via SMS.
The database 115 saves the Calling Line Identity (CLI) and current operator ID with the PEN and PIN to be retrieved per service request.

### Example

Mobile user (X) would like to get a new PEN and PIN code from the Multi-Level Interconnection Management System (MIMS) 110.
Mobile user (X) device 100 uses a SIM with the number 078000000 from mobile operator (A) 105.
The user (X) uses device 100 to send an SMS containing the word “PEN” to the number “333” which has been assigned by the operator 105 for their special services.
The user (X) will receive a confirmation SMS including:
   PEN: 123456789012
   PIN Code: 6543
   To register with (A) send a Message to the number 333 containing your Account PEN and PIN separated with * as follows:
   123456789012*6543

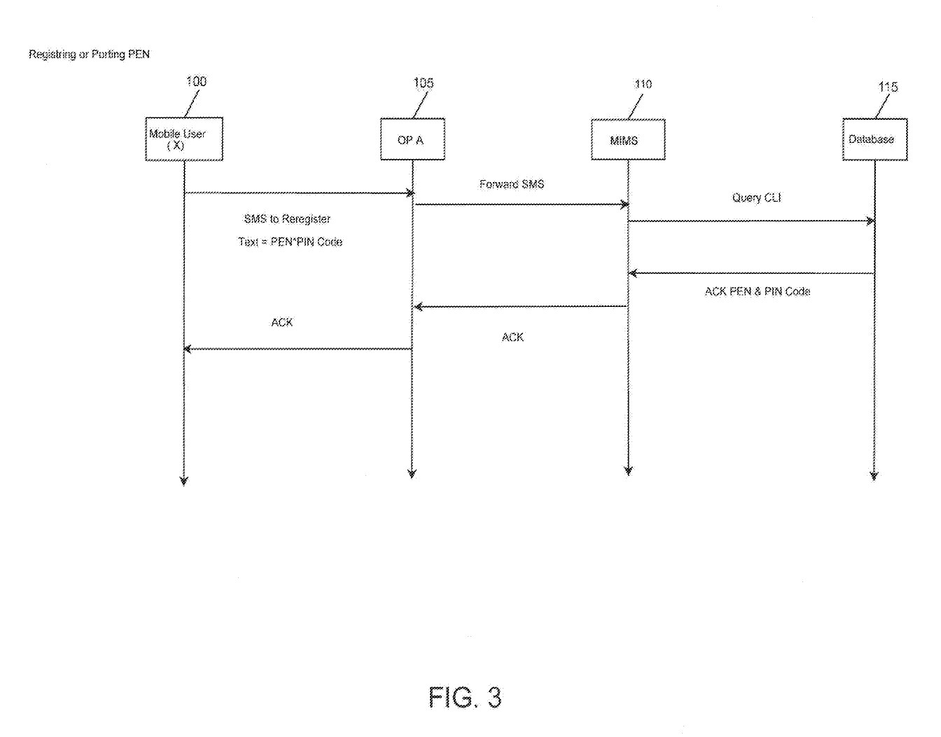

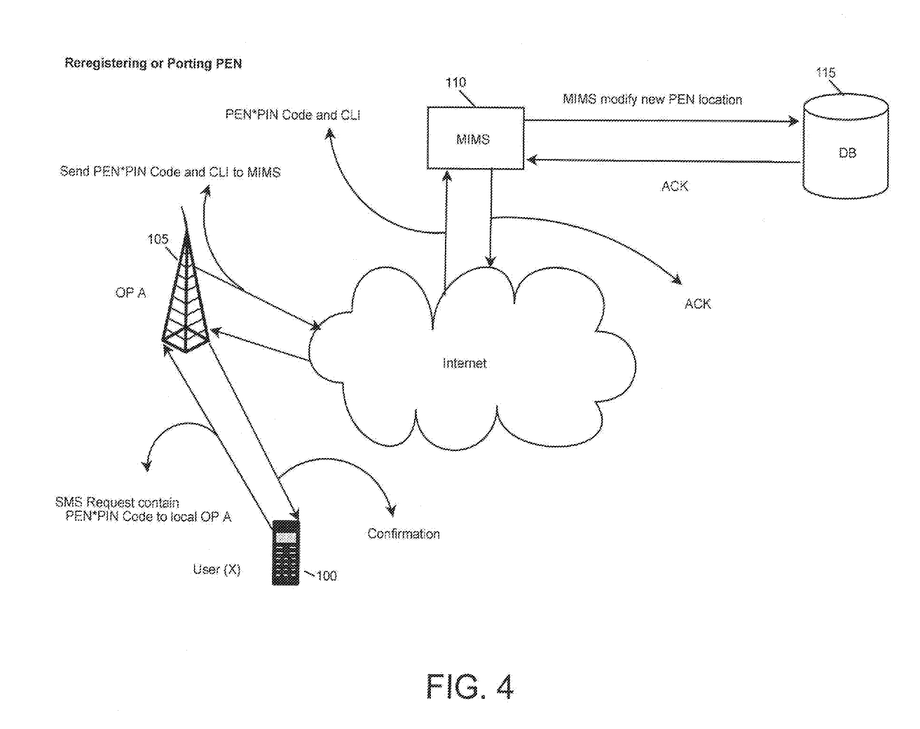

FIGS. 3 and 4 are diagrams showing a method of registering or porting a PEN.

A PEN can only be used to make or receive calls and messages once it is registered and associated with an active mobile number.

Steps to register a PEN (if new or deactivated) or port it to another operator:
User (X) device 100 sends an SMS to a certain short service access number to be assigned by the operator 105 to which the user's line belongs, e.g. (333), the message contains PEN and PIN Code separated with * e.g. 123456789012*6543.
The mobile operator (A) 105 receives the request message and forwards it to the Multi-Level Interconnection Management System (MIMS) 110 over an IP-based network and includes the Calling Line Identity (CLI).
The Multi-Level Interconnection Management System (MIMS) 110 forwards the information to the database 115.
The database 115 attempts to match the PEN and PIN Code, and if matching confirmed, will save the PEN associated with the CLI for mapping purposes.
The MIMS 110 will send a registration confirmation SMS to the operator 105 to deliver it to the user (X) device 100 which sent the request.

### Example

Mobile user (X) would like to register or port a PEN in the Multi-Level Interconnection Management System (MIMS) 110 with a new mobile number.
Mobile user (X) device 100 uses a SIM with the mobile number 078000000 from the Mobile Operator (A) 105.
The user (X) 300 will send SMS to the number “333” which assigned by the operator (A) 305 for their special services, SMS contains: 123456789012*6543
The user (X) via device 100 will receive a registration confirmation SMS contains
   Thanks for registration
   To call or send a Message to any same service network member around the world, dial the number 333 followed by the PEN of the person you like to call e.g. 333123456789012

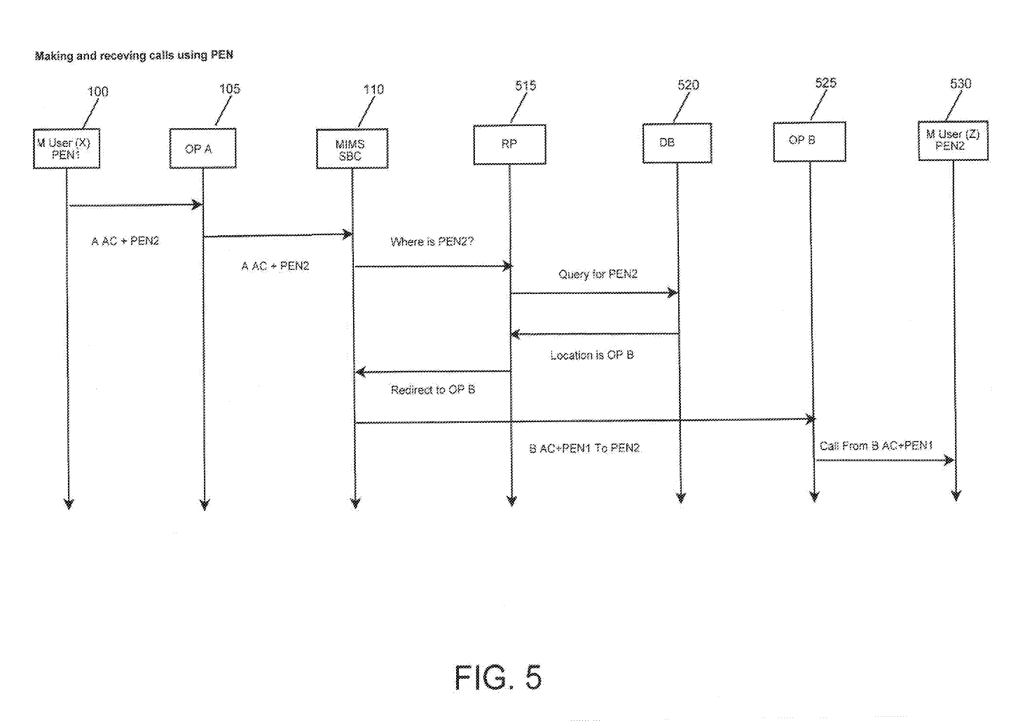

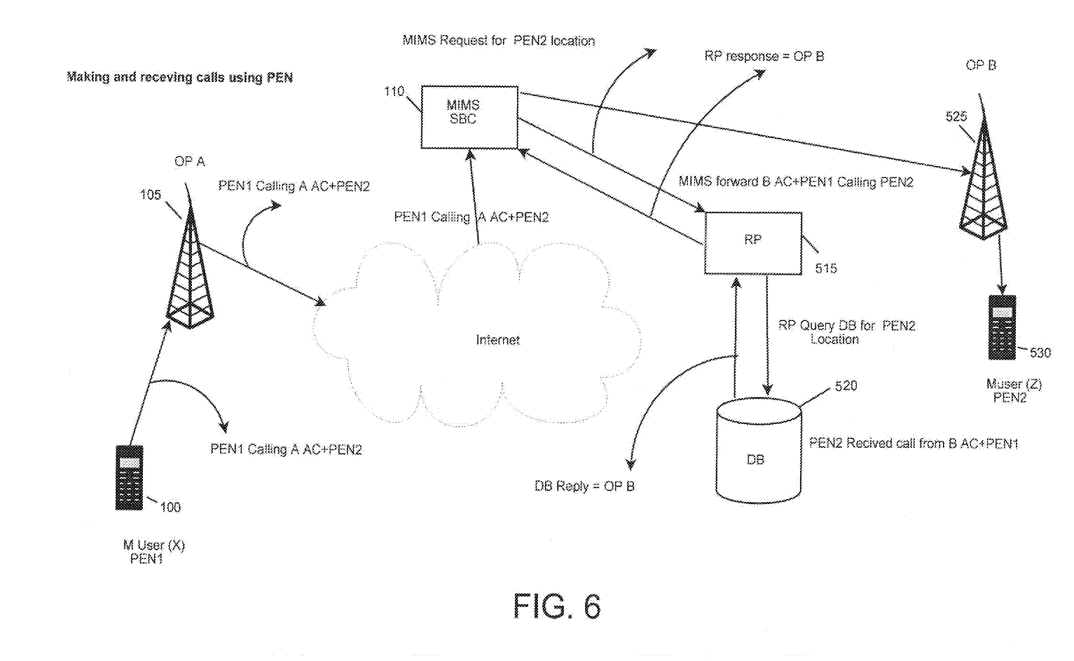

FIGS. 5 and 6 are diagrams showing a method of making and receiving calls using a PEN.

Anyone can join, register and use the interconnectivity facilities of the MIMS system but only through an operator that interconnected to the “MIMS” HUB.

Every operator connected to the “MIMS” HUB provides a short access number for the service so as to allow people to register, subscribe and use the service.
Operator's subscribers are able to make calls to any subscriber in the same service network and with any operator around the world by dialing the short access number followed by the called party PEN.
Calls will hit the operator 105 switch as normal.
The operator 105 will identify the service access number and route the call to the MIMS HUB 110.
Once a call hits the MIMS HUB 110 it will send a request to a routing proxy 515 to get information about which operator the called number of the called party 530 is registered with, and what is the mobile number associated with his PEN.
The routing proxy 515 will send a query to a main database 520, which is the same as database 115 used to generate, register and port PENs, to get the information.
The main database 520 contains data for all registered users include users PEN and the latest phone number associated with the PEN, the operator name and their service access short number (SASN).
The database 520 will respond to the routing proxy 515 with the operator's name and the called party's 530 registered phone number.
The routing proxy 515 will send this information to the MIMS acting as Session Border Controller (SBC) 510.
The SBC 510 will change the Caller ID and replace it with the caller “PEN”
The SBC 510 will send the call to the called party operator 525 as a normal call to deliver to the called party 530.
The called party 530 will know this call is coming for the “MIMS” Hub service member.

### Example

Calling party Mobile user (X) device 100:
Mobile user (X) uses Mobile operator (A) network 105
Mobile user (X) has a phone number: 078000000
Mobile user (X) has a “PEN”: 123456789012
Mobile operator (A) has assigned the Service Access Short Number “333”

Call receiving party (Z) device 530:
Mobile user (Z) use Mobile operator (B) network
Mobile user (Z) has a phone number: 095222222
Mobile user (Z) has a “PEN”: 432156789123
Mobile operator (B) has assigned the Service Access Short Number “252”

Mobile user (X) would like to call Mobile user (Z) with operator (B) 525:
Mobile user (X) device 500 dials the service access short number followed by the PEN of the call receiving party (Z) as the following: 333 432156789123.
Local Operator (A) 105 sends the number 432156789123 to the MIMS 110 with the caller ID CLI 078000000.
The MIMS 110 gets the call receiving party information that showing that the PEN 432156789123 is currently registered and associated with the mobile number 095222222 which is located with operator (B) 525.
The SBC in the MIMS 110 routes the call to operator (B) 525 and replaces the calling party CLI 078000000 with the calling party PEN 123456789012 and adds the service access number of the operator (B) 252 prior to the number.
The call receiving party 530 receives the call and the caller ID he will see will be his current operator 525 access service number followed by the caller PEN 252 123456789012.
The call receiving party 530 can save the number in his phone book as it is and call back the user (A) 500 at any time without changing anything.

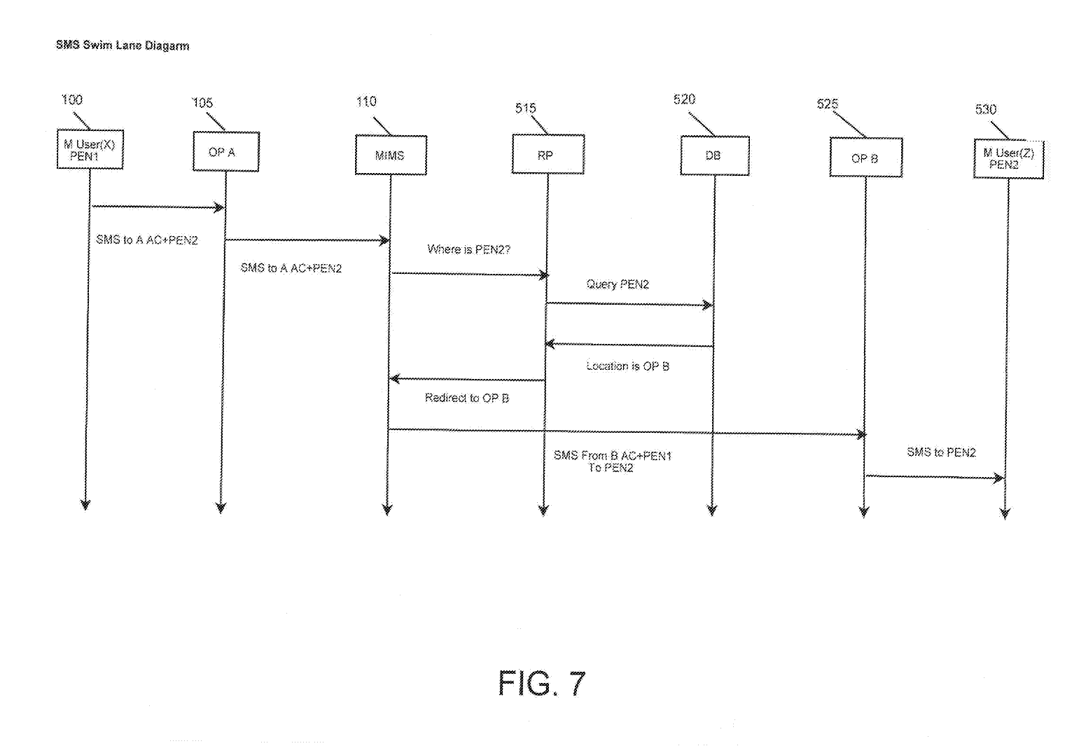

FIGS. 7 & 8 are diagrams showing a method of sending and receiving messages using a PEN.

Anyone can join, register and use the interconnectivity facilities of the MIMS but only through an operator that is interconnected to the MIMS HUB 110.

Every operator connected to the MIMS HUB 110 provides a short access number for the service so as to allow people to register, subscribe and use the service.
Operator's subscribers will be able to send and receive messages (SMS, MMS) to and from any subscriber in the same service network and with any operator around the world by using the short access number followed by the other party PEN.
Messages (SMS, MMS) will be received by the operator 105 system as normal.
The Operator 105 will identify the service access number and route the Messages (SMS, MMS) to the MIMS HUB 110.
Once the Message (SMS, MMS) is received by the MIMS HUB 110 it will send a request to the routing proxy 515 to get information about which operator the receiving party 530 is registered with, and what is the mobile number associated with his PEN.
The routing proxy 515 will send a query to the main database 520 to get the information.
The main database 520 contains data for all registered users and include user's PEN and the latest phone number associated with the PEN, the associated operators name and their service access short number (SASN).
The database 520 will respond to the routing proxy 515 with the operator's name and the other party 530 registered phone number.
The routing proxy 515 will send this information to the MIMS Hub 510 acting as Session Border Controller (SBC).
The SBC 510 will change the Caller ID and replace it with the caller PEN.
The SBC 510 will send the Message (SMS, MMS) to the operator 525 as a normal Message (SMS, MMS) to deliver to the receiving party 530.
The receiving party 530 will know this Message (SMS, MMS) is coming for the MIMS Hub service member 510.

### Example

Message (SMS, MMS) sending party Mobile user (X) device 100:
Mobile user (X) device 100 uses Mobile operator (A) network
Mobile user (X) device 100 has a phone number: 078000000
Mobile user (X) device 100 has a PEN: 123456789012
Mobile operator (A) has assigned the Service Access Short Number “333”

Message (SMS, MMS) receiving party (Z) device 530:
Mobile user (Z) device 530 uses Mobile operator (B) network
Mobile user (Z) device 530 has a phone number: 095222222
Mobile user (Z) device 530 has a PEN: 432156789123
Mobile operator (B) has assigned the Service Access Short Number “252”

Mobile user (X) would like to send a Message (SMS, MMS) to Mobile user (Z) with operator (B) 525.
Mobile user (X) via device 100 uses the services access short number followed by the PEN of the Message (SMS, MMS) receiving party as the following: 333 432156789123.
Local Operator 105 sends the number 432156789123 to the MIMS 510 with the caller ID CLI 078000000.
The MIMS 110 gets the Message (SMS, MMS) receiving party information that showing the PEN 432156789123 is currently registered and associated with the mobile number 095222222 which located with operator (B) 525.
The SBC 510 routes the Message (SMS, MMS) to operator (B) 525 and replaces the sender CLI 078000000 with the sender PEN 123456789012 and adds the service access number of the operator (B) 252 prior to the number.
The Message (SMS, MMS) receiving party 530 receives the Message (SMS, MMS) and the caller ID he will see will be his current operator access service number followed by the caller “PEN” 252 123456789012.
The Message (SMS, MMS) receiving party 530 can save the number in his phone book as it is and reply the Message (SMS, MMS) to the user (A) 100 at any time without changing anything.

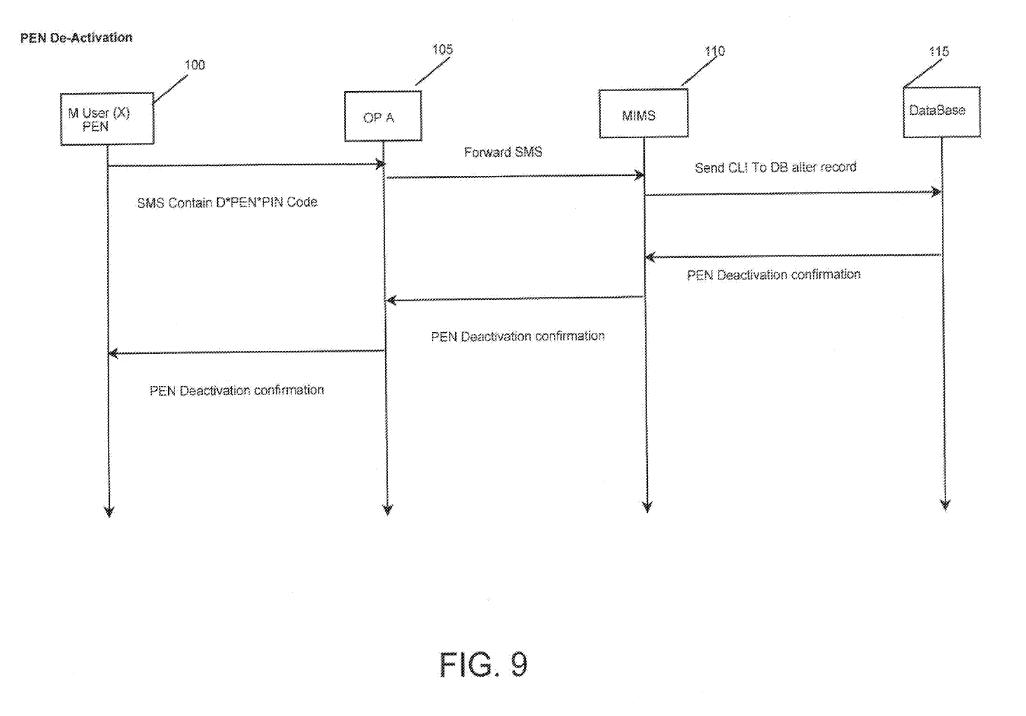

FIGS. 9 & 10 show diagrams for a method of deactivating the PEN.

A PEN can only be used to make or receive calls and messages once and if it is registered and associated with a mobile number in the MIMS.

Any user will be able to deactivate his PEN, so that the PEN may not to be used to make or receive calls and messages.

Steps to deactivate a PEN:
User (X) via device 100 sends an SMS to a certain short service access number to be assigned by the operator 105 to which the user's line belongs, e.g. (333), and the message contains the letter “D” and PEN and PIN Code separated with * e.g. D*123456789012*6543
The mobile operator 105 receives the request message and forwards it to the Multi-Level Interconnection Management System (MIMS) 110 over IP and includes the Calling Line Identity (CLI).
The Multi-Level Interconnection Management System (MIMS) 110 forwards the information to the Database server 115.
The database 115 matches the “PEN” and PIN Code, and, if matching confirmed, will remove the CLI which associated with the PEN, with this step, the PEN will not be active.
The MIMS 110 sends a deactivation confirmation SMS to the operator 105 to deliver it to the user 100 who sent the request.
If the user (X) wishes to re-activate his PEN, he may use the same registration steps shown in FIG. 3 & FIG. 4

### Example

Mobile user (X) would like to deactivate a “PEN” in the Multi-Level Interconnection Management System (MIMS).
Mobile user (X) via device 100 uses a SIM with the mobile number 078000000 from the Mobile Operator (A) 105.
The user (X) via device 100 sends SMS to the number “333” which is assigned by the operator (A) 105 for their special services, SMS contains: D*123456789012*6543
The user (X) device 100 receives a registration confirmation SMS contains
   Your “PEN” is deactivated

A portable extension number (PEN) is used here in place of a telephone number and may be resolved to a telephone number. The telephone number associated with the PEN may change. The PEN is globally unique within the MIMS. The MIMS spans at least two network operators.

Of course, a skilled person would see that alternatives to the above implementation features are available, where appropriate.

A skilled person would also understand that the method described herein would be implemented on any suitable computer architecture.

### ADDITIONAL STATEMENTS

A telecommunication system for managing portable Extension numbers across telecom operators comprising 2 levels: a first level for interconnection between telecom operators across one central system module comprising:
A—a session border controller (SBC) for interconnection between operators;
B—a routing proxy for getting right path between two extensions; and
C—a database for saving a current portable extension number and location; and
   a second level for connecting extensions across their local operators which interconnect to each other by the central system.

Preferably wherein porting extension numbers every Extension is associated temporarily with one regular phone number according to location and current operator.

Preferably wherein SBC interconnecting module comprising: receiving calls from operators and route them to the right destination (other operator) by requesting the routing proxy module for the current Extension location which is the current operator.

Preferably wherein routing proxy module comprising: getting the current Extension operator by requesting the database module for the record belongs to this Extension using the regular phone number as a database key.

Preferably wherein database module comprising: one database record for each portable Extension to join the Extension with the current operator and location, the record will consist of 3 fields:
A—Operator name of ID.
B—Extension number.
C—Regular phone number.

Preferably wherein regular phone number comprising; replacing this field value when user moving from one operator to another the modules involved in this are (SBC), routing proxy (RP), and database.

Preferably wherein user need to register one time to use the system features, comprising:
A—Sending text message containing the word “PEN”.
B—Receiving text message containing his PEN and PIN code.

Preferably wherein receiving text message comprising:
A—Generating a new PEN number and PIN Code.
B—Saving PEN and PIN code and Operator name and user regular phone number in new database record.
C—Sending the PEN and PIN Code to the user phone.

When the user would like to make a call or send SMS, the process will include:
A—Dialing the service access short number SASN of his local operator followed by the other party PEN number.
B—Other party will receive the call or message as originating from the number of the format (SASN) of the local operator+caller PEN number.

Preferably wherein replacing SASN of local operator of the caller with (SASN) of local operator of other party, comprising: Modules involving in this process are, (SBC), (RP) and the database.

Preferably wherein the local operator omits his SASN from the number that dialed by the user and forwards it to the Multi-Level Interconnection Management System (MIMS) over IP.

Preferably wherein (MIMS) replacing the (SASN), comprising:
A—(SBC) request (RP) to get the current operator of the other party.
B—(RP) querying the database for the operator name using the user CLI or regular phone number as a record key and the database will respond with operator name (SASN) value.
C—(SBC) will replace the (SASN) of the caller with the value retuned by the (RP) before forwarding the call to the other party operator.

1. A computer-implemented method of managing telecommunications between telephone line subscribers, the method comprising:
a) at a first telecommunications operator, receiving from a first telecommunications terminal associated with a first subscriber a connection or message request to connect or send a message to a second subscriber, wherein the connection or message request contains a portable extension number associated with the second subscriber;
b) resolving the portable extension number to discover information regarding a telephone number and second telecommunications operator used by the second subscriber;
c) routing the connection or message request to the second subscriber via the second telecommunications operator using at least the telephone number, and including an identifier so that the second telecommunications operator knows that the connection or message request originated for a portable extension number.

2. The method of claim 1, wherein the connection or message request received from the first telecommunications terminal is signaled by a service access short number associated with the first telecommunications operator.

3. The method of claim 1, wherein the first telecommunications operator passes the connection or message request to a session border controller spanning multiple telecommunications operators for resolving and routing.

4. The method of claim 3, wherein the session border controller accesses a database to resolve the telephone number and second telecommunications operator.

5. The method of claim 1, the method further comprising registering a new user by:
receiving, at the first or second telecommunications operator, a new user request text message addressed to a short service access number of the telecommunications operator and containing a pre-determined message body and the calling line identifier of new telecommunications apparatus, and in response:
generating a new and not previously used user portable extension number and personal identification number and associating the portable extension number and personal identification number with the calling line identifier and telecommunications operator in a database; and
returning the new user portable extension number and personal identification number to the new telecommunications apparatus.

6. The method of claim 5, wherein the generating and associating are performed by a central management system spanning multiple telecommunications operators.

7. The method of claim 1, the method further comprising registering or porting a portable extension number by:
receiving, at the first or second telecommunications operator, a registration or porting request text message addressed to a short service access number of the telecommunications operator and containing a pre-determined message body including the portable extension number and personal identification number of a user, and a calling line identifier of the originating telecommunications apparatus, and in response:
associating the portable extension number with the calling line identifier and telecommunications operator in a database; and
returning a confirmation message to the originating telecommunications apparatus.

8. The method of claim 7, wherein the associating is performed by a central management system spanning multiple telecommunications operators.

9. The method of claim 1, wherein the identifier sent with the connection or message request is the portable extension number of the first subscriber.

10. The method of claim 1, wherein each portable extension number is a globally unique number within an overall telecommunications system.

11. A system of managing telecommunications between telephone line subscribers, the system comprising:
a first telecommunications terminal;
a first telecommunications operator;
a second telecommunications terminal;
a second telecommunications operator;
a session border controller;
wherein, the first telecommunications operator is arranged to receive from the first telecommunications terminal a connection or message request to connect or send a message to the second telecommunications terminal, wherein the connection or message request contains a portable extension number associated with the second telecommunications terminal;
the first telecommunications operator is arranged to pass the connection or message request to the session border controller for resolving the portable extension number to discover information regarding a telephone number and the second telecommunications operator associated with the second telecommunications terminal;
the session border controller is arranged to route the connection or message request to the second telecommunications terminal via the second telecommunications operator using at least the telephone number, and is arranged to include an identifier so that the second telecommunications operator knows that the connection or message request originated for a portable extension number.

12. The system of claim 11, wherein the connection or message request received from the first telecommunications terminal is signaled by a service access short number associated with the first telecommunications operator.

13. The system of claim 11, wherein the session border controller spans multiple telecommunications operators.

14. The system of claim 13, wherein the session border controller is arranged to access a database to resolve the telephone number and second telecommunications operator.

15. The system of claim 11, the system further arranged to register a new user by:
receiving, at the first or second telecommunications operator, a new user request text message addressed to a short service access number of the telecommunications operator and containing a pre-determined message body and the calling line identifier of new telecommunications apparatus, and in response:
generating, at the session border controller, a new and not previously used user portable extension number and personal identification number and associating the portable extension number and personal identification number with the calling line identifier and telecommunications operator in a database; and
returning the new user portable extension number and personal identification number to the new telecommunications apparatus.

16. The system of claim 11, the system further arranged to register or port a portable extension number by:
receiving, at the first or second telecommunications operator, a registration or porting request text message addressed to a short service access number of the telecommunications operator and containing a pre-determined message body including the portable extension number and personal identification number of a user, and a calling line identifier of the originating telecommunications apparatus, and in response:
associating, at the session border controller, the portable extension number with the calling line identifier and telecommunications operator in a database; and
returning a confirmation message to the originating telecommunications apparatus.

17. The system of claim 11, wherein the identifier sent with the connection or message request is the portable extension number of the first subscriber.

18. The system of claim 11, wherein each portable extension number is a globally unique number within the telecommunications system.

19. A telecommunication system for managing portable extension numbers across telecom operators comprising 2 levels:
a first level for interconnection between telecom operators across one central system module comprising:
(a) a session border controller (SBC) for interconnection between operators;
(b) a routing proxy for getting a right path between two Extensions; and
(c) a database for saving a current portable Extension number and location; and
a second level for connecting extensions across their local operators which interconnect to each other by the central system.

20. The system of claim 19, wherein every extension is associated temporarily with one regular phone number according to location and current operator.
